(19) United States
(12) Patent Application Publication
(10) Pub. No.: US 2026/0101959 A1
(43) Pub. Date: Apr. 16, 2026

(54) TWO-PIECE INJECTION MOLDED SHOE SYSTEM

(71) Applicant: Triple T Trading Ltd, Marysville, WA (US)

(72) Inventor: Bob Thayer, Marysville, WA (US)

(21) Appl. No.: 19/357,008

(22) Filed: Oct. 13, 2025

Related U.S. Application Data
(63) Continuation of application No. 18/480,182, filed on Oct. 3, 2023, now Pat. No. 12,446,651.

(51) Int. Cl. A43B 3/12; A43B 3/24; A43B 13/22; A43B 13/38

(52) U.S. Cl. CPC A43B 3/128; A43B 3/24; A43B 3/244; A43B 13/22; A43B 13/38

(57) ABSTRACT

A shoe system is disclosed. The system includes a first shoe portion including one or more plugs extending from the first shoe portion. The system further includes a second shoe portion including one or more apertures formed in the second shoe portion and sized to receive the one or more plugs of the first shoe portion. The second shoe portion is configured to be removably connected to the first shoe portion when the one or more plugs of the first shoe portion are received in the one or more apertures of the second shoe portion. The first and second shoe portions may each consist of a single injection piece from EVA foam. The second shoe portion may further include a tread portion configured to make the second shoe portion have desirable characteristics for a given situation or usage, for example, to make the second shoe portion oil- and/or slip-resistant.

### CROSS-REFERENCES TO RELATED APPLICATIONS

This patent application is a continuation of U.S. non-provisional application Ser. No. 18/480,182, filed Oct. 3, 2023, which is incorporated into the present disclosure by this reference.

### FIELD OF THE INVENTION

This disclosure is directed to a two-piece injection molded shoe system and applications thereof, including a multi-function shoe system.

### BACKGROUND

Shoes have traditionally been limited to particular applications. For instance, a runner may utilize a running shoe; a hiker, a hiking boot; an office worker, a loafer or heel; and a person on vacation, a flip-flop. Since shoes have traditionally been limited to a particular application, a person looking to perform different activities has needed to have multiple different shoes specific to each of those activities. This has had a very limiting effect on consumers, and can be quite costly to them as well.

Shoes have also traditionally been constructed of different materials based on these different applications. For some applications, shoes must be constructed of materials that result in the shoe having specific qualities necessary or desirable for the given application. For example, first response workers may find themselves in a variety of treacherous conditions, such that having a shoe with an oil-resistant or slip-resistant sole is necessary or desirable. The first response worker thus may own, for example, close-toed shoes with an oil- and slip-resistant sole. But the first response worker has traditionally been limited to that close-toed shoe, unable to readily switch to something more comfortable like a flip-flop or slide, because such casual shoes do not have an oil- and slip-resistant sole. So even in her downtime, the first response worker must wear the close-toed shoe with the oil-and-slip resistant sole, which can be quite limiting and undesirable for her.

Even for consumers without the need for a shoe for a specific application, traditional shoes can be quite limiting. To own, for example, a clog, a sneaker, a flip-flop, and a slide has traditionally required the consumer to own four separate pairs of shoes. This requires four separate purchases of four complete pairs of shoes, often from four different companies, which can be burdensome, expensive, and time-intensive for the consumer.

Embodiments of the invention address these and other shortcomings of the prior art.

### BRIEF DESCRIPTION OF THE DRAWINGS

FIG. 1A is a top view of a two-piece injection molded shoe system according to embodiments of the invention.

FIG. 1B is a lateral side view of a two-piece injection molded shoe system according to embodiments of the invention.

FIG. 1C is a medial side view of a two-piece injection molded shoe system according to embodiments of the invention.

FIG. 1D is a front view of a two-piece injection molded shoe system according to embodiments of the invention.

FIG. 1E is a back view of a two-piece injection molded shoe system according to embodiments of the invention.

FIG. 1F is a bottom view of a two-piece injection molded shoe system according to embodiments of the invention.

FIG. 2A is a top view of the second shoe portion of a two-piece injection molded shoe system according to embodiments of the invention.

FIG. 2B is a lateral side view of the first and second shoe portions of a two-piece injection molded shoe system according to embodiments of the invention.

FIG. 2C is a medial side view of the first and second shoe portions of a two-piece injection molded shoe system according to embodiments of the invention.

FIG. 2D is a front view of the first and second shoe portions of a two-piece injection molded shoe system according to embodiments of the invention.

FIG. 2E is a back view of the first and second shoe portions of a two-piece injection molded shoe system according to embodiments of the invention.

FIG. 2F is a bottom view of a two-piece injection molded shoe system according to embodiments of the invention.

FIG. 3 is a lateral side view of a multi-function shoe system according to embodiments of the invention.

FIG. 4 is a flow chart of a method of using an embodiment multi-function shoe system according to embodiments of the invention.

### DETAILED DESCRIPTION OF THE EMBODIMENTS

The embodiments described herein provide a two-piece shoe system and, more particularly, a two-piece injection molded shoe system having interchangeable uppers or outsoles, providing the ability for a user to have multiple styles of uppers to wear in one shoe system.

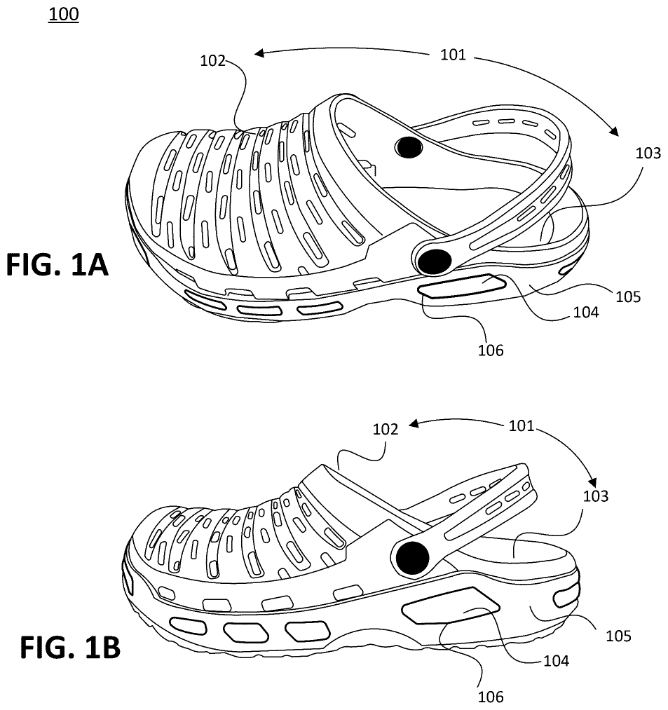

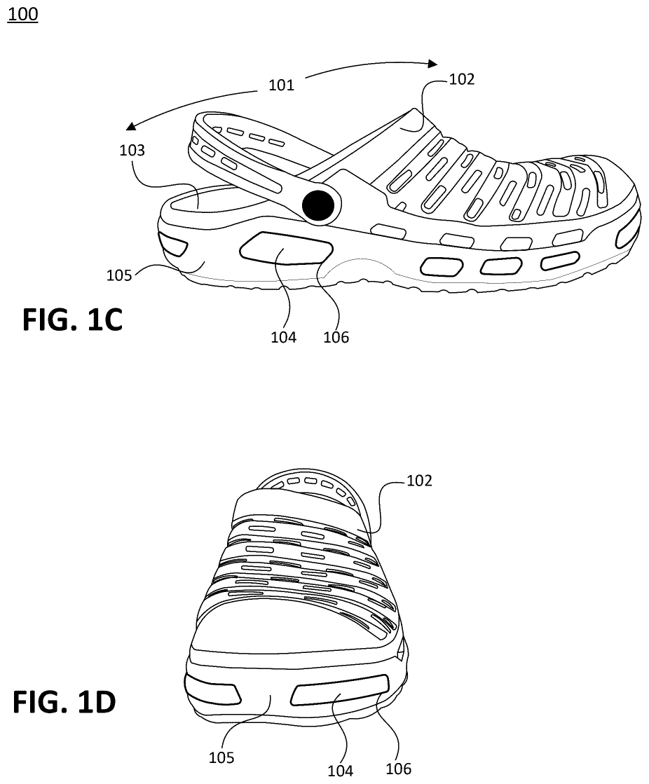

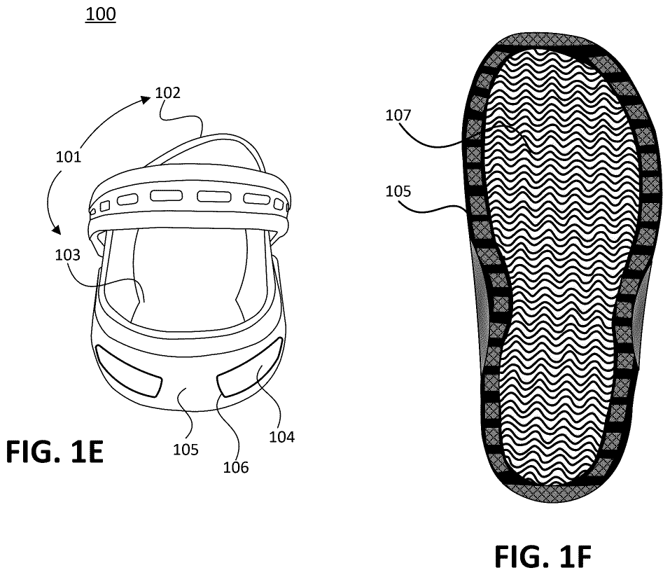

FIGS. 1A-1E show one shoe of a two-piece injection molded shoe system 100 according to an embodiment of the invention, wherein a first shoe portion 101 and a second shoe portion 105 are securely, semi-permanently, removably connected to each other via plugs 104 extending from the first shoe portion 101 being received in corresponding apertures 106 formed in the second shoe portion 105. While only one shoe is shown in FIGS. 1A-1E, it should be understood that the system 100 would typically be comprised of two shoes, one for a left foot and one for a right foot, which would be mirror images of each other, as is standard for pairs of shoes.

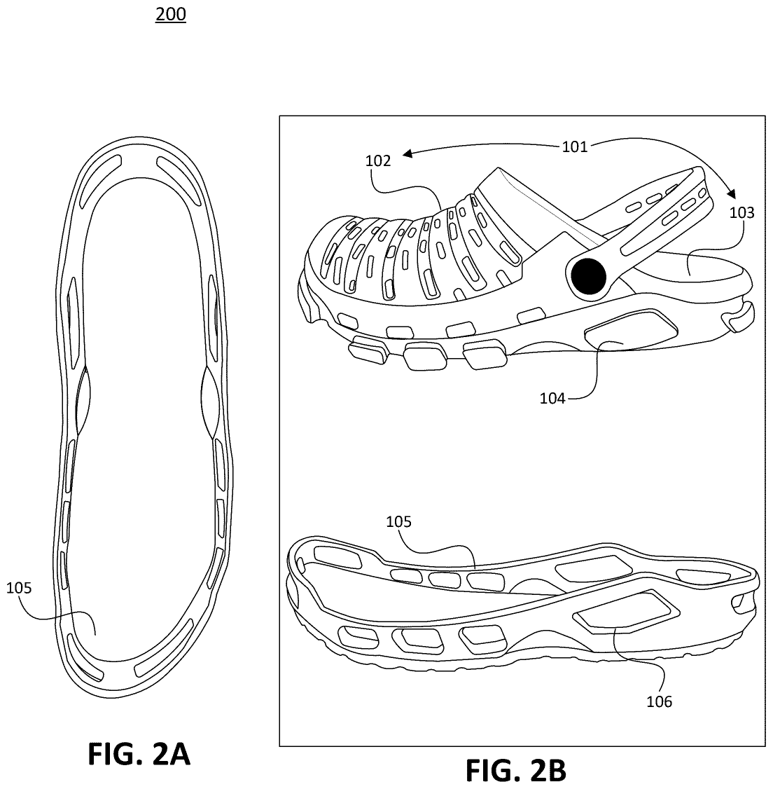

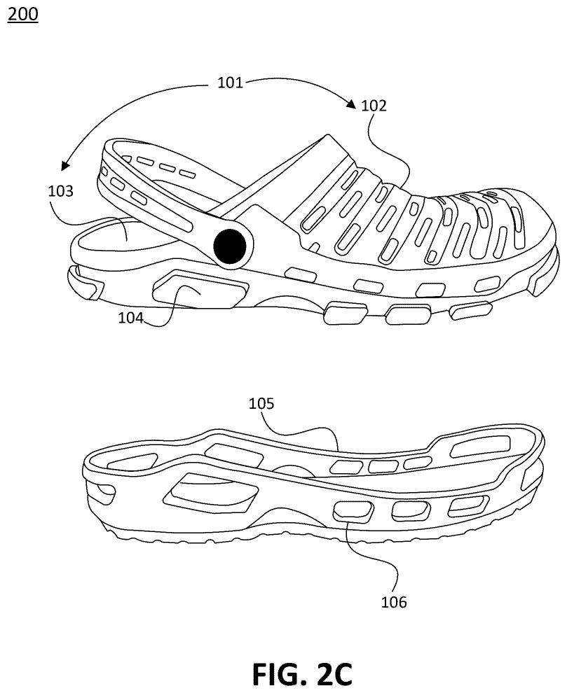

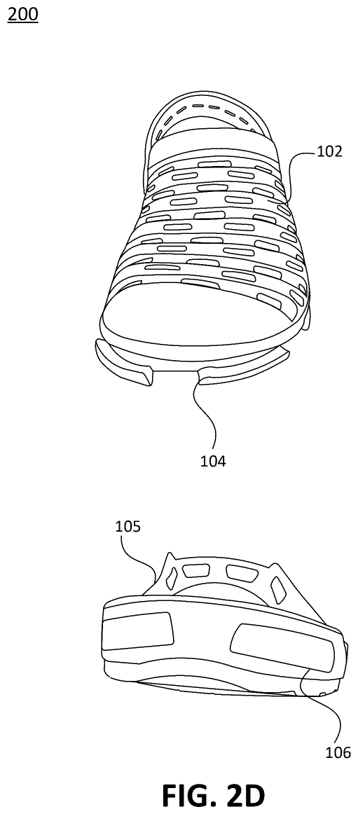

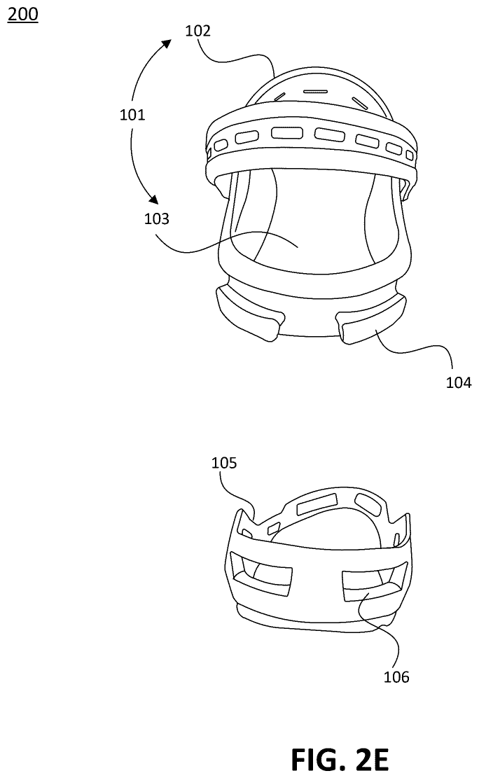

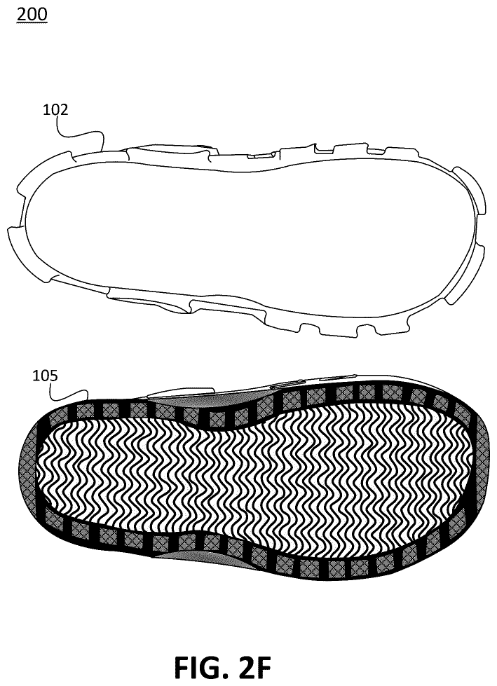

FIGS. 2A-2E show a two-piece injection molded shoe system 200 according to an embodiment of the invention, wherein the first shoe portion 101 and the second shoe portion 105 are disconnected via removal of plugs 104 from the apertures 106. Such a connection permits interchangeability between the first and second shoe portions using one's hands, but not merely using one's feet or merely while walking in the two-piece shoe system 100. In this manner, the first shoe portion 101 and second shoe portion 105 do not detach while the user is wearing or using the shoe system 100. While only one shoe is shown in FIGS. 2A-2E, it should be understood that the system would typically be comprised of two shoes, one for a left foot and one for a right foot, which would be mirror images of each other, as is standard for pairs of shoes.

Shoe system 200 includes a first shoe portion 101 with an upper portion 102 and an insole portion 103. The upper portion 102 is configured to be worn substantially over and around the sides and top of a foot of a wearer, while the insole portion 103 is configured to be worn substantially under the foot of a wearer. The upper portion 102 and the insole portion 103 may be formed as a single injection piece. In an embodiment, the upper portion 102 and insole portion 103 are formed as a single injection piece from ethylene-vinyl acetate (EVA) foam, a soft and durable polymer that is light weight and cushioning in nature. Other materials can alternatively be used. In another embodiment, the upper portion 102 and the insole portion 103 may be formed as separate pieces that are combined through any conventional means.

As shown in FIGS. 1A-1E, the upper portion 102 can be in the style of a clog with a heel strap. However, the upper portion 102 can be any shoe style. For instance, the upper portion 102 could be in the style of a clog without a heel strap, a mule, a slip-on, a sneaker, a close-toed shoe, a slide, a flip-flop, a boot, or any other style of shoe.

The shoe system 100 also includes a second shoe portion 105. The second shoe portion 105 is configured to fit substantially under the insole portion 103 of the first shoe portion 101, with sides that permit the insole portion 103 of the first shoe portion 101 to be received within the second shoe portion 105. The second shoe portion 105 may be formed as a single injection piece. In an embodiment, the second shoe portion is formed as a single injection piece from EVA foam. Other materials can alternatively be used. In another embodiment, the second shoe portion 105 may be formed as multiple pieces that are combined through any conventional means, for example, as an outsole with an additional sole attached thereto.

In an embodiment, the second shoe portion 105 includes a tread portion 107 on a bottom side of the second shoe portion 105 (see FIG. 1F). The tread portion 107 may be a separate piece combined with the second shoe portion 105 through any conventional means, for example, by gluing the tread portion 107 to the bottom side of the second shoe portion 105. Alternatively, second shoe portion 105 and tread portion 107 may be formed as a single injection piece from EVA foam. Tread portion 107 may be sized smaller than the bottom side of the second shoe portion 105, such that a portion of the bottom side of the second shoe portion 105 remains exposed. Alternatively, tread portion 107 may be sized to be substantially the same size and shape as the bottom side of the second shoe portion 105.

In an embodiment, the tread portion 107 includes a tread pattern configured to make the second shoe portion 105 have desirable characteristics for a given situation or usage. For example, the tread pattern can be configured to make the second shoe portion 105 oil-resistant and/or slip-resistant. In another embodiment, the tread pattern can be configured to make the second shoe portion 105 ideal for hiking or similar applications. In another embodiment, the bottom side of the second shoe portion 105 may be made of a material that makes the bottom side oil- and/or slip-resistant, instead of or in addition to the tread pattern itself being configured to make the second shoe portion oil-resistant and/or slip-resistant.

In an embodiment, and as can be seen in FIGS. 2B-2F, the first shoe portion 101 includes one or more plugs 104 configured to be received in one or more apertures 106 in the second shoe portion 105, as shown in FIGS. 1A-1D. In an embodiment, the one or more apertures 106 of the second shoe portion 105 are sized to receive the one or more plugs 104 of the first shoe portion. In an embodiment, the one or more plugs 104 are sized such that they extend substantially all the way through the one or more apertures 106 in the second shoe portion 105. In this manner, the first shoe portion 101 and second shoe portion 105 can be securely, semi-permanently, removably connected to each other by receiving the one or more plugs 104 of the first shoe portion 101 in the corresponding one or more apertures 106 of the second shoe portion 105. By extending substantially all the way through the corresponding apertures 106, the plugs 104 provide for a secure, semi-permanent, removable attachment, as well as the ability for the shoe system 101 to have a contrasting design where the first shoe portion 101 and the second shoe portion 105 are different colors, patterns, or textures.

As shown in the embodiment in FIGS. 2B-2F, first shoe portion 101 may include one or more plugs 104 extending substantially laterally from the lateral side of the first shoe portion 101 (FIG. 2B), one or more plugs 104 extending substantially laterally from the medial side of the first shoe portion 101 (FIG. 2C), one or more plugs 104 extending substantially laterally from the front side (toe area) of the first shoe portion 101 (FIG. 2D), and one or more plugs extending substantially laterally from the back side (heel area) of the first shoe portion 101 (FIG. 2E). In this manner, multiple plugs 104 extend substantially laterally from all sides of the first shoe portion 101.

In the embodiment shown in FIGS. 2B-2F, four plugs 104 extend substantially laterally from the lateral side of the first shoe portion 101 (FIG. 2B), four plugs 104 extend substantially laterally from the medial side of the first shoe portion 101 (FIG. 2C), two plugs 104 extend substantially laterally from the front side (toe area) of the first shoe portion 101 (FIG. 2D), and two plugs 104 extend substantially laterally from the back side (heel area) of the first shoe portion 101 (FIG. 2E). Correspondingly, four apertures 106 are formed in the lateral side of the second shoe portion 105 (FIG. 2B), four apertures 106 are formed in the medial side of the second shoe portion 105 (FIG. 2C), two apertures 106 are formed in the front side (toe area) of the second shoe portion 105 (FIG. 2D), and two apertures 106 are formed in the back side (heel area) of the second shoe portion 105 (FIG. 2E). In this manner, plugs 104 extend substantially laterally from all sides of the first shoe portion 101 and have corresponding apertures 106 in the second shoe portion 105, enabling a secure, semi-permanent, removable connection between the first shoe portion 101 and the second shoe portion 105 when they are connected via the plugs 104 being received in their corresponding apertures 106. Other numbers, configurations, and placements of plugs 104 and corresponding apertures 106 can be used to enable a secure, semi-permanent, removable connection between the two shoe portions. Such a connection permits interchangeability between the first and second shoe portions using one's hands, but not merely using one's feet or merely while walking in the two-piece shoe system 101. In this manner, the first shoe portion 101 and second shoe portion 105 do not detach while the user is wearing or using the shoe system 100.

In an embodiment, the one or more plugs 104 extending laterally from the sides of the first shoe portion 101 are substantially parallelogram in shape, with the one or more apertures 106 in the second shoe portion 105 also being substantially parallelogram in shape and sized to receive the plugs 104. However, any combination and types of shapes can be used for the plugs and corresponding apertures, such as but not limited to triangles, rectangles, parallelograms, circles, squares, rhombuses, ovals, pentagons, hexagons, heptagons, octagons, and so on. These and other shapes can also be used to create different contrasting designs when the first shoe portion 101 and second shoe portion 105 are different colors, patterns, or textures. For example, the plugs 104 and corresponding apertures 106 can be substantially star-shaped, creating a contrasting star design; heart-shaped, creating a contrasting heart design; or any other conceivable shape that still allows for the plugs 104 and apertures 106 to function to securely, semi-permanently, removably connect the two shoe portions.

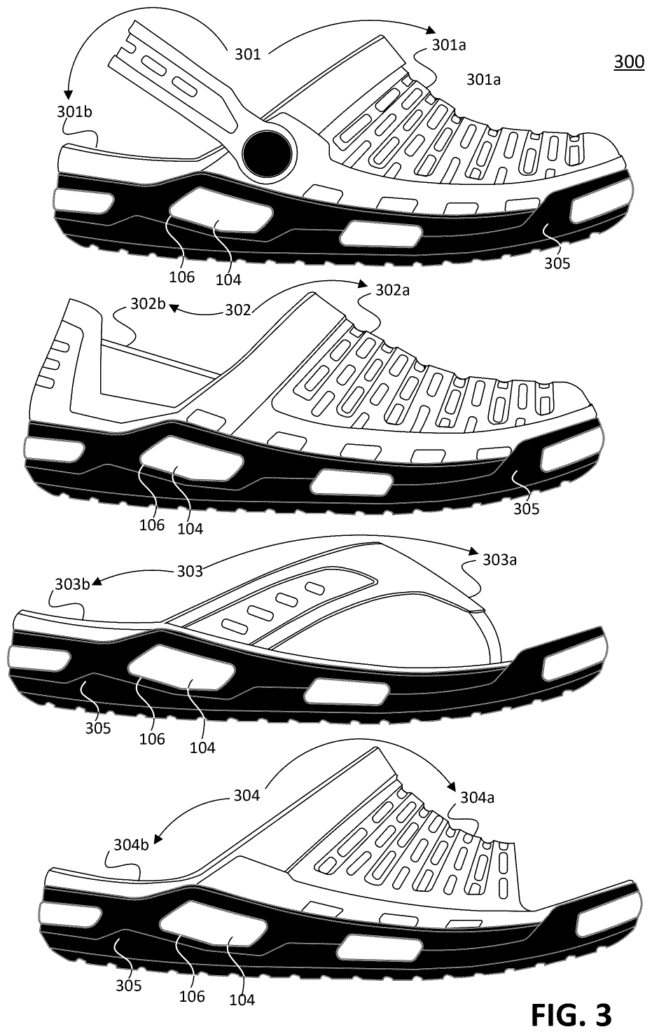

Turning to FIG. 3, an embodiment multi-function shoe system 300 is shown. While in FIG. 3 a second shoe portion 305 is shown in connection with each first shoe portion 301, 302, 303, 304 to illustrate the secure, semi-permanent, removable connection between each shoe portion, in an embodiment the multi-function shoe system 300 only includes one second shoe portion 305, configured to be securely, semi-permanently, removably connected to multiple first shoe portions 301, 302, 303, 304. In this manner, multiple first shoe portions 301, 302, 303, 304 are interchangeable with a single second shoe portion. Thus, with a single multi-function shoe system 300, a user has the ability to obtain and wear multiple styles of shoes via interchangeable first shoe portions 301, 302, 303, 304 and only one second shoe portion 305.

In the embodiment multi-function shoe system 300 shown in FIG. 3, the system 300 includes one first shoe portion 301 in the style of a clog with heel strap, one first shoe portion 302 in the style of a loafer, one first shoe portion 303 in the style of a flip-flop, and one first shoe portion 304 in the style of a slide. However, first shoes portions 301, 302, 303, 304 can be any other combination of shoe styles (clog without a heel strap, a slip-on, a mule, a sneaker, a close-toed shoe, a slide, a flip-flop, a boot, or any other style of shoe); can all be the same shoe style but in different colors, textures, or patterns; can all be different shoes styles in the same color, texture, or pattern; or any other combination of styles, colors, textures, or patterns. In an embodiment, the multi-function shoe system 300 may include fewer first shoe portions, for example, may only include two or three first shoe portions. In another embodiment, the multi-function shoe system 300 may include more first shoe portions, for example, may include five or more first shoe portions. In another embodiment, the multi-function shoe system 300 may include more than one second shoe portions.

Each of the first shoe portions 301, 302, 303, and 304 include one or more plugs 104 extending from the first shoe portions. In an embodiment, one or more plugs 104 extend substantially laterally from one or more sides of each first shoe portion 301, 302, 303, 304.

Each of the first shoe portions 301, 302, 303, 304 include an upper portion 301a, 302a, 303a, 304a, and an insole portion 301b, 302b, 303b, 304b. Each upper portion 301a, 302a, 303a, 304a is configured to be worn substantially over and around the sides and the top of a foot of a wearer, and each insole portion 301b, 302b, 303b, 304b is configured to be worn substantially under the foot of a wearer. In an embodiment, each upper portion 301a, 302a, 303a, 304a is formed as a single injection piece with its respective insole portion 301b, 302b, 303b, 304b, such that each first shoe portion 301, 302, 303, 304 is formed as a single injection piece. In an embodiment, the single injection piece is formed from EVA foam. Other materials can alternatively be used. In another embodiment, each upper portion 301a, 302a, 303a, 304a may be formed as a separate piece from its respective insole portion 301b, 302b, 303b, 304b, which are combined through any conventional means.

In an embodiment, multi-function shoe system 300 also includes a second shoe portion 305 configured to be securely, semi-permanently, removably connected to each of the first shoe portions 301, 302, 303, 304. The second shoe portion 305 includes one or more apertures 106 through which the one or more plugs 104 of any of the first shoe portions 301, 302, 303, 304 can be received, the plugs 104 extending substantially all the way through the corresponding apertures 106. By extending substantially all the way through the corresponding apertures 106, the plugs 104 provide for a secure, semi-permanent, removable attachment, as well as the ability for a contrasting design where the first shoe portion 301, 302, 303, 304 connected to the one second shoe portion 305 is a different color, pattern, or texture from the second shoe portion 305.

In an embodiment, each first shoe portion 301, 302, 303, 304 uses approximately the same number, size, shape, and configuration of plugs 104, and the second shoe portion 305 uses a corresponding number, size, shape, and configuration of apertures 106. In this manner, the second shoe portion 305 is interchangeable with each of the first shoe portions 301, 302, 303, 304.

In the embodiment shoe system 300 shown in FIG. 3, the plugs 104 extending substantially laterally from the sides of each first shoe portion 301, 302, 303, 304 are substantially parallelogram in shape, and the corresponding apertures 106 in the second shoe portion 305 are also substantially parallelogram in shape and sized to receive the plugs 104. However, any combination and types of shapes can be used for the plugs and corresponding apertures in shoe system 300, so long as each first shoe portion 301, 302, 303, 304 uses approximately the same number, size, shape, and configuration of plugs 104. For instance, the plugs and corresponding apertures may be triangles, rectangles, parallelograms, circles, squares, rhombuses, ovals, pentagons, hexagons, heptagons, octagons, and so on. These and other shapes can also be used to create different contrasting designs when each first shoe portion 301, 302, 303, 304 is a different color, pattern, or texture than the one second shoe portion 305. For example, the plugs 104 and corresponding apertures 106 can be substantially star-shaped, creating a contrasting star design; heart-shaped, creating a contrasting heart design; or any other conceivable shape that still allows for the plugs 104 and apertures 106 to function to securely, semi-permanently, removably connect the one second shoe portion 305 to each of the first shoe portions 301, 302, 303, 304 at a given time.

In an embodiment shoe system 300, the one second shoe portion 305 includes a tread portion 107 on a bottom side of the one second shoe portion 305, such as the tread portion 107 in FIG. 1F. The tread portion 107 may be a separate piece combined with the one second shoe portion 305 through any conventional means, for example, by gluing the tread portion 107 to the bottom side of the one second shoe portion 305. Alternatively, the one second shoe portion 305 and tread portion 107 may be formed as a single injection piece from EVA foam. As in FIG. 1F, tread portion 107 may be sized smaller than the bottom side of the one second shoe portion 305. Alternatively, tread portion 107 may be sized to be substantially the same size and shape as the bottom side of the one second shoe portion 305.

In an embodiment shoe system, the tread portion 107 includes a tread pattern configured to make the one second shoe portion 305 have desirable characteristics for a given situation or usage. For example, the tread pattern can be configured to make the one second shoe portion 305 oil-resistant and/or slip-resistant. In another embodiment, the tread pattern can be configured to make the one second shoe portion 305 ideal for hiking or similar applications. In another embodiment, the bottom side of the second shoe portion 305 may be made of a material that makes the bottom side oil- and/or slip-resistant, instead of or in addition to the tread pattern itself being configured to make the second shoe portion oil-resistant and/or slip-resistant. In this manner, a consumer having a need for a particular type of shoe sole but a desire for multiple shoe styles can meet both the need and desire with a single shoe system 300. For example, a first responder may need a shoe with an oil-resistant or slip-resistant sole. With the shoe system 300, the first responder can have multiple styles of shoe, all with the same oil- and/or slip-resistant sole, providing versatility, flexibility, and customizability to the user.

In an embodiment shoe system 300, instead of multiple first shoe portions and one second shoe portion, there is one first shoe portion and two or more second shoe portions. The first shoe portion includes an upper portion and insole portion and is formed as a single injection piece of EVA foam. Other materials can alternatively be used. Each of the second shoe portions are formed as separate single injection pieces of EVA foam. Other materials can alternatively be used. The one first shoe portion includes one or more plugs 104 configured to be received in corresponding one or more apertures 106 formed in each of the two or more second shoe portions, as described herein with reference to other embodiments. Each of the two or more second shoe portions use approximately the same number, size, shape, and configuration of apertures 106, corresponding to the number, size, shape, and configuration of plugs 104 extending from the one first shoe portion. In this manner, the one first shoe portion is interchangeable with each of the two or more second shoe portions. In such a shoe system, each of the second shoe portions can be configured for a different purpose. For example, the shoe system 300 could include one second shoe portion that is oil- and/or slip-resistant; one second shoe portion that is substantially smooth and thus more appropriate for indoor wear; and so on. In this manner, a single shoe system 300 can provide a single type of shoe (for example, a clog with a heel strap) capable of multi-purpose use.

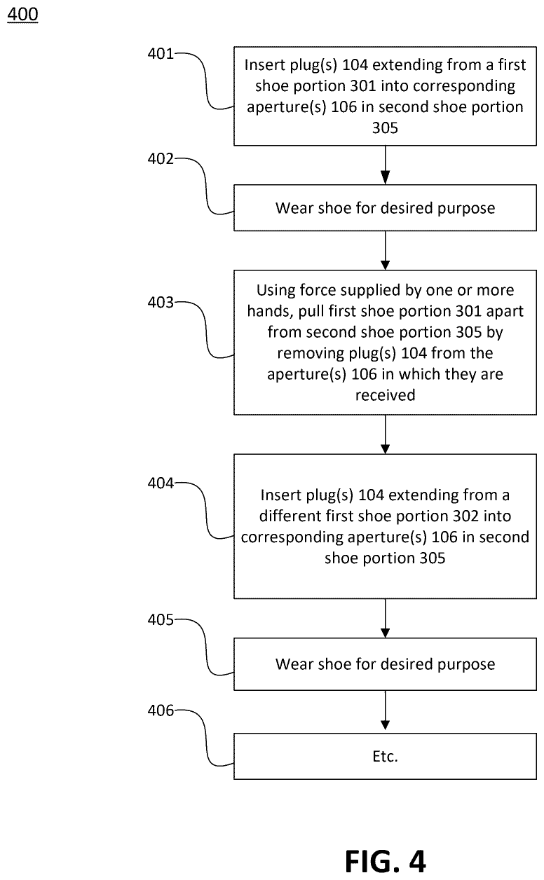

Turning to FIG. 4, a method of using an embodiment multi-function shoe system is shown. In block 401, first shoe portion 301 is connected to the second shoe portion 305 by a user with her hands, inserting the plug(s) 104 extending from the first shoe portion 301 into the corresponding aperture(s) 106 of the second shoe portion 305. The user can then wear the shoe for her desired purpose, as shown at block 402. For example, in an embodiment where the first shoe portion 301 is in the style of a clog with a heel strap and the user is a nurse, the user can wear the shoe while on her shift at the hospital. In block 403, the user can disconnect first shoe portion 301 from second shoe portion 305 by supplying force with one or more of her hands, pulling the first shoe portion 301 apart from the second shoe portion 305 by removing plug(s) 104 of the first shoe portion 301 from the corresponding aperture(s) 106 of the second shoe portion. The user can then select a new first shoe portion, for example, first shoe portion 302, and at block 404, connect first shoe portion 302 to the second shoe portion 305 by inserting the plug(s) 104 extending from first shoe portion 302 into the corresponding aperture(s) 106 of the second shoe portion 305. The user can then wear this new shoe for her desired purpose, as shown at block 405. For example, in an embodiment where first shoe portion 302 is in the style of a loafer and the user is the same nurse, by changing the first shoe portion 302 the nurse is now ready to go from her shift to the grocery store. These steps of connecting and disconnecting different first shoe portions from the second shoe portion can be repeated indefinitely and as desired by the user, as shown at block 406. In this manner, the embodiment multi-function shoe system 300 provides versatility, flexibility, and customizability to the user.

This written description makes reference to particular features. It is to be understood that the disclosure in this specification includes all possible combinations of those particular features. For example, where a particular feature is disclosed in the context of a particular example configuration, that feature can also be used, to the extent possible, in the context of other example configurations.

Also, when reference is made in this application to a method having two or more defined steps or operations, the defined steps or operations can be carried out in any order or simultaneously, unless the context excludes those possibilities.

Furthermore, the terms “comprises” and “includes” and their grammatical equivalents are used in this application to mean that other components, features, steps, processes, operations, etc. are optionally present. For example, an article “comprising” or “which comprises” components A, B, and C can contain only components A, B, and C, or it can contain components A, B, and C along with one or more other components. Likewise, an article “including” or “which includes” components A, B, and C can contain only components A, B, and C, or it can contain components A, B, and C along with one or more other components.

Although specific example configurations have been described for purposes of illustration, it will be understood that various modifications may be made without departing from the spirit and scope of the disclosure.

What is claimed is:

1. A method of assembling a shoe system, the method comprising the steps of:
selecting a first shoe portion having an upper portion and an insole portion, the first shoe portion further having one or more plugs extending from the first shoe portion;
selecting a second shoe portion having one or more apertures formed in the second shoe portion and sized to receive the one or more plugs of the first shoe portion, the second shoe portion further having a bottom surface structured to contact a walking surface; and
inserting the one or more plugs of the first shoe portion in the one or more apertures of the second shoe portion such that the one or more plugs extend substantially all the way through the one or more apertures.

2. The method of claim 1, in which selecting the first shoe portion comprises selecting a type of upper chosen from the group consisting of a clog-style upper, a slide-style upper, a flip-flop style upper, and a loafer-style upper.

3. The method of claim 1, in which selecting the first shoe portion comprises selecting a first shoe portion having one or more plugs that are substantially of a shape chosen from the group consisting of a parallelogram, a rectangle, a triangle, a circle, a square, a rhomboid, an oval, a pentagon, a hexagon, a heptagon, an octagon, a star, and a heart.

4. The method of claim 3, in which the one or more apertures of the second shoe portion are substantially of a shape chosen from the group consisting of a parallelogram, a rectangle, a triangle, a circle, a square, a rhomboid, an oval, a pentagon, a hexagon, a heptagon, an octagon, a star, and a heart.

5. The method of claim 1, in which selecting the second shoe portion comprises selecting a tread portion of the bottom surface structured for a desired use.

6. The method of claim 1, in which selecting the second shoe portion comprises selecting a second shoe portion having a bottom surface that is slip-resistant or oil-resistant.

7. The method of claim 1, in which selecting the second shoe portion comprises selecting a second shoe portion having a different color, pattern, or texture from the first shoe portion.

8. A method of assembling a shoe system, the method comprising the steps of:
selecting a first shoe portion having an upper portion and an insole portion, the first shoe portion further having one or more plugs extending laterally from the first shoe portion;
selecting a second shoe portion having one or more apertures formed in at least one side of the second shoe portion and sized to receive the one or more laterally extending plugs of the first shoe portion, the second shoe portion further having a bottom surface structured to contact a walking surface; and
inserting the one or more laterally extending plugs of the first shoe portion in the one or more apertures of the second shoe portion such that the one or more plugs extend substantially all the way through the one or more apertures.

9. The method of claim 8, in which selecting the first shoe portion comprises selecting a type of upper chosen from the group consisting of a clog-style upper, a slide-style upper, a flip-flop style upper, and a loafer-style upper.

10. The method of claim 8, in which selecting the first shoe portion comprises selecting a first shoe portion having one or more plugs that are substantially of a shape chosen from the group consisting of a parallelogram, a rectangle, a triangle, a circle, a square, a rhomboid, an oval, a pentagon, a hexagon, a heptagon, an octagon, a star, and a heart.

11. The method of claim 10, in which the one or more apertures of the second shoe portion are substantially of a shape chosen from the group consisting of a parallelogram, a rectangle, a triangle, a circle, a square, a rhomboid, an oval, a pentagon, a hexagon, a heptagon, an octagon, a star, and a heart.

12. The method of claim 8, in which selecting the second shoe portion comprises selecting a tread portion of the bottom surface structured for a desired use.

13. The method of claim 8, in which selecting the second shoe portion comprises selecting a second shoe portion having a bottom surface that is slip-resistant or oil-resistant.

14. The method of claim 8, in which selecting the second shoe portion comprises selecting a second shoe portion having a different color, pattern, or texture from the first shoe portion.

15. A method of changing a shoe from a first type to a second type in a multi-function shoe system, the method comprising the steps of:
selecting one of at least two first shoe portions, each of the at least two first shoe portions having an upper portion and an insole portion, and each of the at least two first shoe portion having one or more plugs extending from the first shoe portion;
selecting a second shoe portion, the second shoe portion having one or more apertures formed in the second shoe portion and sized to receive the one or more plugs of either of the at least two first shoe portions;
inserting the plugs of the selected one of the at least two first shoe portions in the one or more apertures of the second shoe portion such that the one or more plugs extend substantially all the way through the one or more apertures;
removing the plugs of the selected one of the at least two first shoe portions from the one or more apertures; and
inserting the plugs of the second of the at least two first shoe portions in the one or more apertures of the second shoe portion such that the one or more plugs extend substantially all the way through the one or more apertures.

16. The method of claim 15, in which selecting the one of at least two first shoe portions comprises selecting a type of upper chosen from the group consisting of a clog-style upper, a slide-style upper, a flip-flop style upper, and a loafer-style upper.

17. The method of claim 15, in which selecting the one of at least two first shoe portions comprises selecting a first shoe portion having one or more plugs that are substantially of a shape chosen from the group consisting of a parallelogram, a rectangle, a triangle, a circle, a square, a rhomboid, an oval, a pentagon, a hexagon, a heptagon, an octagon, a star, and a heart.

18. The method of claim 17, in which the one or more apertures of the second shoe portion are substantially of a shape chosen from the group consisting of a parallelogram, a rectangle, a triangle, a circle, a square, a rhomboid, an oval, a pentagon, a hexagon, a heptagon, an octagon, a star, and a heart.

19. The method of claim 15, in which selecting the second shoe portion comprises selecting a tread portion of the bottom surface structured for a desired use.

20. The method of claim 15, in which selecting the second shoe portion comprises selecting a second shoe portion having a bottom surface that is slip-resistant or oil-resistant.
